(19) United States
(12) Patent Application Publication
(10) Pub. No.: US 2017/0052999 A1
(43) Pub. Date: Feb. 23, 2017

(54) METHOD AND DEVICE FOR PROCESSING RESOURCES

(71) Applicants: LE HOLDINGS (BEIJING) CO., LTD., Beijing (CN); LE SHI INTERNET INFORMATION TECHNOLOGY CORP., BEIJING, Beijing (CN)

(72) Inventors: Hongmei ZHANG, Beijing (CN); Lei NIU, Beijing (CN); Zhi XIE, Beijing (CN); Zheng SUN, Beijing (CN); Sijia SUN, Beijing (CN)

(73) Assignees: LE HOLDINGS (BEIJING) CO., LTD., Beijing (CN); LE SHI INTERNET INFORMATION TECHNOLOGY CORP., BEIJING, Beijing (CN)

(21) Appl. No.: 15/244,704

(22) Filed: Aug. 23, 2016

Related U.S. Application Data
(63) Continuation of application No. PCT/CN2016/087332, filed on Jun. 27, 2016.

(30) Foreign Application Priority Data
Aug. 20, 2015 (CN) 201510516301.4

(51) Int. Cl. G06F 17/30

(52) U.S. Cl. CPC G06F 17/30477; G06F 17/30554; G06F 17/30528; G06F 17/30598

(57) ABSTRACT

An embodiment of the present disclosure discloses a method and a device for processing resources. The method comprises steps of receiving search terms entered by a user, searching a resource database according to the search terms to obtain at least one type of resource data matched with the search terms, wherein the resource database stores mapping relationships between key word and at least one type of resource data; displaying the at least one type of resource data; and according to the user's selected operation on the at least one type of resource data, calling a corresponding application to show the resource data corresponding to the selected operation in the application. The present disclosure may search and obtain the at least one type of resource data corresponding to the search terms by entering the search terms once, and may directly open the resource data in the corresponding application, thus enhancing the search efficiency.

### CROSS-REFERENCE TO RELATED APPLICATIONS

The present disclosure is a continuation of International Application No. PCT/CN2016/087332 filed on Jun. 27, 2016, which is based upon and claims priority to Chinese Patent Application No. 201510516301.4, entitled “METHOD AND DEVICE FOR PROCESSING RESOURCES”, filed on Aug. 20, 2015, the entire contents of all of which are incorporated herein by reference.

### FIELD OF TECHNOLOGY

The present disclosure generally relates to the field of network technologies, in particular, to a method and a device for processing resources.

### BACKGROUND

Along with the continuous development of network technologies, resources in the network are increasingly rich, so it is needed to quickly find target resources among tremendous resources.

Usually, the tremendous resources belong to different types. In the prior, various types of vertical search engines are provided such that users may research resources of corresponding type in the various types of vertical search engines. For example, a user is interested in Jay Chou. The user wants to search the songs of Jay Chou, he/she may search the songs of Jay Chou in the song type of vertical search engines; if the user wants to search the videos of Jay Chou, he/she may search the movies and TV series concerning Jay Chou in the video type of vertical search engines, and search high-definition wallpapers and photos of Jay Chou in the picture type of vertical search engines, etc.

Thus it is clear that, users are needed to search multiple times in different types of vertical search engines to acquire various types of resources, causing low search efficiency.

### SUMMARY

An embodiment of the present disclosure discloses a method and a device for processing resources, overcoming the defect of obtaining various types of resources by multiple search operations in the prior art, and enhancing the search efficiency.

According to one aspect of the present disclosure, an embodiment of the present disclosure discloses a method, including:

receiving a search term sent by a terminal;

extracting a key word from the search term, searching a resource database according to the key word to obtain at least one type of resource data matched with the search term, wherein the resource database stores the mapping relationship between every key word and the at least one type of resource data;

sending the at least one type of resource data matched with the search term to the terminal such that the terminal calls a corresponding application according to a user's selected operation on the at least one type of resource data, and shows the resource data corresponding to the selected operation.

According to another aspect of the present disclosure, an embodiment of the present disclosure discloses a method for processing resources, comprising:

receiving a search term entered by a user, and sending the search term to a server;

receiving the at least one type of resource data matched with the search term sent by the server, wherein the server has a resource database, and the resource database stores mapping relationship between a key word extracted from the search term and the at least one type of resource data such that the at least one type of resource data are capable of being obtained through key word search;

displaying at least one type of resource data;

calling a corresponding application according to a user's selected operation on the at least one type of resource data, and displaying the resource data corresponding to the selected operation.

According to another aspect of the present disclosure, an embodiment of the present disclosure discloses an electronic device for processing resources, including: at least one first processor; and a first memory communicably connected with the at least one first processor for storing instructions executable by the at least one first processor, wherein execution of the instructions by the at least one first processor causes the at least one first processor to:

receive search terms sent by a terminal;

extract a key word from a search term, searching a resource database according to the search term to obtain at least one type of resource data matched with the search term, wherein the resource database stores mapping relationship between each key word and at least one type of resource data; and

send the at least one type of resource data matched with the search term to the terminal such that the terminal calls a corresponding application according to a user's selected operation on the at least one type of resource data, and showing the resource data corresponding to the selected operation.

According to another aspect of the present discloses, an embodiment of the present disclosure discloses an electronic device for processing resources, including: at least one second processor; and a second memory communicably connected with the at least one second processor for storing instructions executable by the at least one second processor, wherein execution of the instructions by the at least one second processor causes the at least one second processor to:

receive a search term entered by a user, and send the search term to a server;

receive the at least one type of resource data matched with the search term sent by the server, wherein the server has a resource database, and the resource database stores the mapping relationships between key word extracted from the search term and the at least one type of resource data such that the at least one type of resource data are capable of being obtained through key word search;

display at least one type of resource data; and

call a corresponding application according to a user's selected operation on the at least one type of resource data, and displaying the resource data corresponding to the selected operation.

According to another aspect of the present disclosure, there is provided an electronic device, comprising:

a memory, having instructions therein;

one or more processors, configured for executing the instructions such that the electronic device executes operations for processing resources, the operations comprising:

receiving search terms sent by a terminal;

extracting key words from the search terms, searching a resource database according to the key words to obtain at least one type of resource data matched with the search terms, wherein the resource database stores the mapping relationship between every key word and the at least one type of resource data; and,

sending the at least one type of resource data matched with the search terms to the terminal such that the terminal calls a corresponding application according to a user's selected operation on the at least one type of resource data, and shows the resource data corresponding to the selected operation.

According to another aspect of the present disclosure, there is provided an electronic device, comprising:

a memory, having instructions therein;

one or more processors, configured for executing the instructions such that the electronic device executes operations for processing resources, the operations comprising:

receiving a search term entered by a user, and sending the search term to a server;

receiving the at least one type of resource data matched with the search term sent by the server, wherein the server has a resource database, and the resource database stores mapping relationship between a key word extracted from the search term and the at least one type of resource data such that the at least one type of resource data are capable of being obtained through key word search;

displaying at least one type of resource data;

calling a corresponding application according to a user's selected operation on the at least one type of resource data, and displaying the resource data corresponding to the selected operation.

According to another aspect of the present disclosure, there is provided a computer readable medium, storing the computer program for executing the method above.

The present disclosure has the following beneficial effects:

the method and device according to the embodiments of the present disclosure may obtain at least one type of resources through one search operation, and may show the corresponding resources in an application. Compared with the prior art which needs multiple search operations in different types of vertical search engines, the present disclosure improves search efficiency.

The above description is a summary of the solution of the present disclosure. In order to more clearly describe the technical means of the present disclosure, the content of the description may be executed. Moreover, in order to ensure that the above and other objectives, characteristics and advantages of the present disclosure more understandable, embodiments of the present disclosure are described below.

### BRIEF DESCRIPTION OF THE DRAWINGS

To more clearly describe the technical solution in the embodiments of the present disclosure or in the prior art, the following are brief introduction of the attached drawings used to describe the technology in the embodiments or in the prior art. Obviously, the attached drawings described below involve some embodiments of the present disclosure. For those originally skilled in this field, other drawings may be made according to those drawings without creative labor.

FIG. 1 is a step flowchart of a method for processing resources according to a first embodiment of the present disclosure.

FIG. 2 is a step flowchart of a method for processing resources according to a second embodiment of the present disclosure.

FIG. 3 is a step flowchart of a method for processing resources according to a third embodiment of the present disclosure.

FIG. 4 is a step flowchart of a method for processing resources according to a fourth embodiment of the present disclosure.

FIG. 5 is a structural block diagram of a device for processing resources according to an embodiment of the present disclosure.

FIG. 6 is a structural block diagram of a device for processing resources according to another embodiment of the present disclosure.

FIG. 7 schematically illustrates a block diagram of an electronic device for executing the method according to the present disclosure.

FIG. 8 schematically illustrates a storage unit for keeping or carrying program codes for realizing the method according to the present disclosure.

### DESCRIPTION OF THE EMBODIMENTS

To make the objectives, technical solutions and advantage of the embodiments of the present disclosure more clear, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field may obtain other embodiments without creative labor, which all shall fall within the protection scope of the present disclosure.

### Embodiment 1

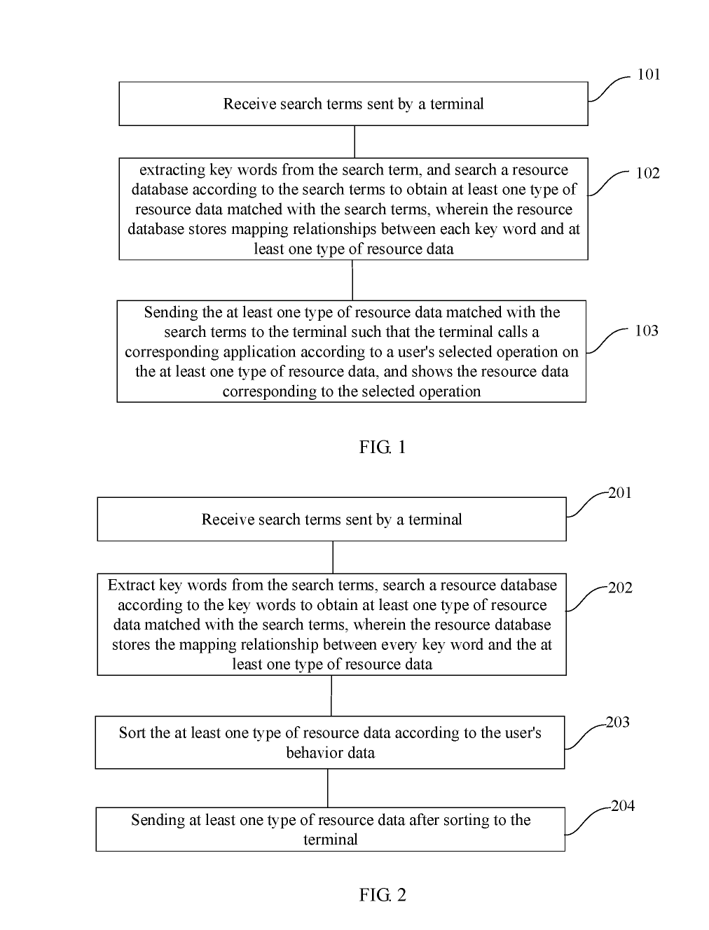

Refer to FIG. 1, which illustrates a step flowchart of a method for processing resources according to a first embodiment of the present disclosure. The method specifically may include the steps as follows.

Step 101: Receive search terms sent by a terminal.

The embodiment of the present disclosure may be applied to support of a search client with a search function. The search client may operate in an electronic device such that a user conveniently enters search terms into the search client through the electronic device. To better understanding, the embodiment of the present disclosure mainly takes a mobile phone as an example for description, which may be a cross reference for tablet personal computers, PCs (personal computers) and other electronic devices.

According to one application example of the present disclosure, a search interface of the search client displays a search input box, and the search input box receives search terms entered by users. For example, a search term entered by a user is “Jay Chou”. The terminal receives the search term input by the user and then sends to the server, the server receives the search term sent by the server. Of course, in actual application, for those ordinarily skilled in this field, various input modes such as keypad input, handwriting input and voice input are supported by the terminal, and the embodiment of the present disclosure has no limit in the specific input mode, as long as the server may receive the search term from the terminal.

Step 102: extracting key words from the search term, and search a resource database according to the search terms to obtain at least one type of resource data matched with the search terms, wherein the resource database stores mapping relationships between each key word and at least one type of resource data.

The embodiment of the present disclosure may integrate different types of resource data into a resource database such that the resource database stores various mapping relationships between key word and a plurality of types of resource data. Here, the key words may be used to represent indexes of a plurality of types of resource data in the resource database. To search the resource database according to the search terms, matching between the search terms and the key words in the resource database is implemented; and the matching succeeds, at least one type of resource data corresponding to the key words may be used as at least one type of resource data matched with the search terms; if the matching between the search terms and all key words in the resource database fails, it may be regarded that the search fails, which means that the resource data does not include at least one resource data matched with the search terms, wherein the resource data may be involved with any APP (Application), for example, calendars, wallpapers, songs, videos, shopping, tickets, weather, travel, maps, etc. For example, songs related to Jay Chou in the song APP, movies and MV participated by Jay Chou in the video APP, high-definition wallpapers concerning Jay Chou in the wallpaper APP, events and dynamics about Jay Chou in calendar APP may be integrated into the resource database. In this way, when the user enters the search terms “Jay Chou”, data resources, corresponding to various APPs, matched with “Jay Chou” may be searched in the resource database, and then resources data corresponding to various APPs may be searched by one search operation, avoiding users from repeatedly searching different APPs and enhancing search efficiency.

In an optimal embodiment of the present disclosure, the resource database may be established by the steps as follows.

Step S11: Collecting a plurality of types of resource data according to key words.

Step S12: Establishing mapping relationships between the key words and a plurality of types of resource data.

Step S13: Storing the mapping relationships between the key words and a plurality of types of resource data into the resource database.

In an application example of the present disclosure, a resource database may be pertinently established according to a plurality of types of resource data, for example, songs related to Jay Chou in the song APP, movies and MV participated by Jay Chou in the video APP, high-definition wallpapers concerning Jay Chou in the wallpaper APP, events and dynamics about Jay Chou in calendar APP. Specifically, first, the concern labels are defined as “Jay Chou”; then, a plurality of types of resource data may be collected from the Internet or from locally stored resources, and the collected a plurality of types of resource data may be related to the concern label “Jay Chou”, for example, Jay Chou's songs, movies, etc.; next, mapping relationships between the concern label “Jay Chou” and Jay Chou's songs, and mapping relationships between the concern label “Jay Chou” and Jay Chou's movies, etc. are established; and finally, the mapping relationships are stored in the resource database, wherein the concern labels are the key words in the resource database. When a user enters the search terms “Jay Chou”, the resource database is searched by taking “Jay Chou” as the key word, and then a plurality of types of resource data such as songs, movies, MV and wallpapers corresponding to the concern label “Jay Chou” matched with the search terms may be searched.

Of course, the above steps for establishing the resource database are an application example of the present disclosure. In practical application, other means may be used to establish the resource database. The present disclosure does not limit in the modes for establishing the resource database. For example, the resource database may also be established by the following steps: first, collecting a plurality of types of resource data, extracting the same concern labels from the a plurality of types of resource data; then, establishing mapping relationships between the concern labels and a plurality of types of resource data; and finally, storing the mapping relationships between the concern labels and a plurality of types of resource data into the resource data.

Step 103: Sending the at least one type of resource data matched with the search terms to the terminal such that the terminal calls a corresponding application according to a user's selected operation on the at least one type of resource data, and shows the resource data corresponding to the selected operation.

In the embodiment of the present disclosure, a plurality of types of resource data obtained by search according to the search terms, for example songs, movies, MVs, wallpapers, etc. corresponding to the search terms “Jay Chou”, may be displayed on the search interface for being operated by a user, for example browse or selection.

According to the embodiment of the present disclosure, according to the resource data selected by the user, an application corresponding to the resource data may be directly called and opened, and the application may display the resource data. Wherein the application corresponding to the resource data may be used for representing the application of the resource data corresponding to the selected operation. For example, when the resource data corresponding to the selected operation are song resources, the corresponding application may be an audio player; for the movie resources, the corresponding application may be a video player; for example again, when the resource data corresponding to the selected operation are wallpaper resources, the corresponding application may be a photo viewer. The applications may specifically be application clients installed in an electronic device. Compared with applications embedded by the existing search engines in the webpages, the application clients have more functions than those of the webpage type applications to facilitate use by users, and are independent from the search access, thus bringing better experience for users.

According to another application example of the present disclosure, when a user selects one song of Jay Chou according to the displayed search results, the user may directly open the audio player that has been installed in the current electronic device, and operate the audio player to play the song.

In an optional embodiment of the present disclosure, if the current device is equipped with a plurality of audio players, the current device may display a prompt box; the prompt box is used for asking for the user's selection on the audio player for playing the resource data, and the corresponding audio player is switched on according to the user's selection to play the song. Or, the correlation relationship between the resource data and the application may be established in advance, for example, the application correlated to the video resource is Letv video application, and the application correlated to song resources is TTPlayer, etc. The present disclosure has no limit in the specific correlation relationships between the resource data and the applications and the specific establishment modes thereof. Therefore, the process that the user need to find and switch on the audio player in the device and select songs to be played after searching the required song resources may be avoided, improving the search efficiency. For example again, when selecting a certain wallpaper resource concerning Jay Chou according to the displayed search results, the user may directly open the wallpaper application in the current device, and then the wallpaper application will show the wallpaper resources.

In conclusion, in this embodiment of the present disclosure, it is capable to receive search terms sent by a terminal; extract key words from the search terms, searching a resource database according to the key words to obtain at least one type of resource data matched with the search terms, wherein the resource database stores the mapping relationship between every key word and the at least one type of resource data; send the at least one type of resource data matched with the search terms to the terminal such that the terminal calls a corresponding application according to a user's selected operation on the at least one type of resource data, and shows the resource data corresponding to the selected operation thus changing the situation that the user needs to repeatedly search different search engines to obtain different types of resource data. Therefore, the search operation of the user is simplified, search efficiency enhanced, and user experience improved.

### Embodiment 2

On the basis of the first embodiment, this embodiment may also include the following optional solution.

Relative to the first embodiment, this embodiment searches the resource database according to the search terms to obtain at least one type of resource data matched with the search terms. The method may also include: sorting the at least one type of resource data according to user behavior data, and then the step of displaying the at least one type of resource data may specifically include: displaying the sorted at least one type of resource data.

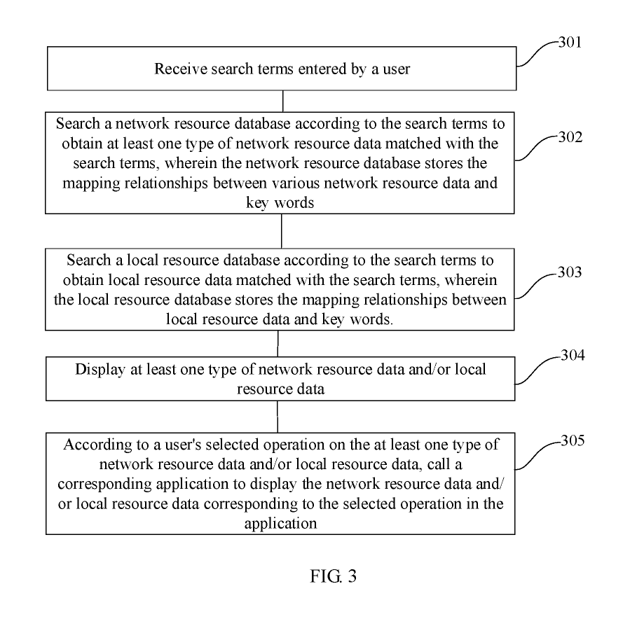

Refer to FIG. 2, which illustrates a step flowchart of a method for processing resources according to the second embodiment of the present disclosure. The method specifically may include the following steps.

Step 201: Receive search terms sent by a terminal.

Step 202: Extract key words from the search terms, search a resource database according to the key words to obtain at least one type of resource data matched with the search terms, wherein the resource database stores the mapping relationship between every key word and the at least one type of resource data.

Step 203: Sort the at least one type of resource data according to the user's behavior data.

In a specific application, every user has different behavioral habits, hobbies and interests, so this embodiment of the present disclosure sorts the at least one type of resource data according to the user behavior data such that the sequence of the at least one type of resource data displayed to different users is different, satisfying the behavioral habits, hobbies and interests of every user. For example, a user recently watched a movie of Jay Chou. This means that the user was interested in movies of Jay Chou in recent days. Then, when the user searches “Jay Chou”, movie resources related to Jay Chou may be displayed on the top and followed by the songs and wallpaper resources of Jay Chou, etc., so the user may quickly select the movie resources of Jay Chou.

According to an optimal embodiment of the present disclosure, the step of sorting the at least one type of resource data according to user behavior data may specifically include the following steps.

Step S21: Search the user behavior data corresponding to the user identifier information from the mapping relationship between the user identifier information and the user behavior data.

Wherein the user identifier information may specifically be account information, user name, etc., of a user to identify the user identity exclusively. When the user logs in the search client of the present disclosure, the user may acquire the user identifier information thereof, and through recording the user behavior data, for example search behaviors, watch behaviors, collection behaviors, etc., the mapping relationship between the user identifier information and the user behavior data may be established. When the user logs in the client again, the behavior data of the user may be found through the user identifier information; the at least one type of resource data which are searched are sorted according to the behavior data, and the resource data conforming to the user behavior data rank first for selection by the user.

Step S22: Sort the at least one type of resource data according to the user behavior data.

According to this embodiment of the present disclosure, the at least one type of resource data may be sorted according to the correlation between the resource data and the user behavior data, and the resource data of high correlation rank first. For example, when the currently searched resource data include songs, movies and wallpaper resources, etc. of Jay Chou, from the current user behavior data, it is known that the user recently watched movies of Jay Chou, so in comparison with the resource data such as songs and wallpapers, it is known that the movies of Jay Chou are more highly correlated to the user behavior data, so the movies of Jay Chou may rank before songs. In this way, the finally obtained sorting sequences of the resource data for different users are different, and the rank of the resource data displayed for each user conforms to the user behavior data. Therefore, this embodiment of the present disclosure may research and display at least one type of resource data conforms to the user behavior data, enhancing search efficiency and improving user experience at the same time.

According to another optimal embodiment of the present disclosure, the user behavior data may specifically include historical application information. Then, the step of sorting the at least one type of resource data according to the user behavior data may specifically include: sorting the at least one type of resource data according to the correlation between the resource data and the historical application information.

In a specific application, the historical application information may be resource information searched or browsed by a user recently. The historical application information may reflect the recent hobbies of the user, so ranking resource data highly correlated to the historical application information first among the research results may improve the hit rate of the search results. Optionally, the correlation between the resource data and the historical application information may be determined through the frequency of utilization. For example, by searching the behavior data of a current user, it is known that the user recently watched movies of Jay Chou. Then, the correlation between the resource data concerning the movies of Jay Chou and the historical application information may be increased, for example, the correlation between the resource data and the historical application information may be initially set as 0; if it is known that the current user watched the movie of Jay Chou once recently through the historical information, the correction corresponding to the resource data about the movies of Jay Chou may be added by 1; and if the user watched the movies of Jay Chou twice in recent time, the correction corresponding to the resource data about the movies of Jay Chou may be added by 2, so the resource data about the movies of Jay Chou has a high correlation. In this way, when the at least one type of resource data are sorted, the resource data about the movies of Jay Chou may rank first among the search results. Of course, the above correlation calculation mode is only an application example of the present disclosure. During actual application, those ordinarily skilled in this field may use other modes to calculate the correlation between the resource data and the historical application information. The present disclosure has no limit in the specific mode and specific time of correlation calculation. The historical application information may reflect the user's historical behavioral habits, so when the at least one type of resource data are sorted according to the correlation to the historical application information, the sorting sequence may conform to the historical behavioral habits of the user, thus enhancing the bit rate of the search results.

According to another optimal embodiment of the present disclosure, the user behavior data may specifically include user interest information. Then, the step of sorting the at least one type of resource data according to the user behavior data may specifically include:

sorting the at least one type of resource data according to the correlation between the resource data and the user interest information.

According to this embodiment of the present disclosure, a statistics operation may be executed on the user interest information according to the user's historical behavior data, and the resource data related to the user interest information is given with a high correlation, so the resource data that the user is interested may rank first among the research results during the sorting. Wherein the user interest information may be acquired through the user behavior data such as concerns and collection, or the resource data information mostly searched by the user may be obtained by statistic operation on the historical search behavior data of the user to determine the user interest information. Users vary with interest information, so when the at least one type of resource data are sorted according to the correlation to the user interest information, the sorting results conform to the interests and hobbies of different users, thus enhancing the hit rate of the search results, wherein the calculation mode the correlation between the resource data and the user interest information may be the calculation mode of the correlation between the resource data and the historical application information. The present disclosure has not limit in the calculation mode of the two correlations.

Besides, the user behavior data may specifically include use habit information. The use habit information may include time, location and specific behaviors of habitual use of a user. For example, the time of habitual use of a user may be recorded as 8:00-9:00 and the location be recorded in an area from Zhongguancun to the International Trade Hotel. At this time and in this area, the user uses Letv videos frequently. When the at least one type of resource data are sorted, the sorting may be executed according to the use habit information of the user.

The steps of sorting the at least one type of resource data according to the user behavior data are described in detail, wherein the user behavior data are not limited to the above described historical application information, user interest information and use habit information. It is understandable that, those ordinarily skilled in this field may use one or combinations of several of the user behavior data upon actual demands, or other user behavior data to sort the at least one type of resource data. The present disclosure has no limit in the specific content of the user behavior data.

According to another optimal embodiment of the present disclosure, the method may also include: updating the user behavior data according to the user's selected operation on the at least one type of resource data.

For example, a user selects a certain song of Jay Chou from the displayed at least one type of resource data, and stores the song of Jay Chou into the user behavior data corresponding to the user identifier information of the user. When the user searches Jay Chou next time, the correlation of the resource data conforming to the behavior data may be weighted; besides, the update time of the user behavior data corresponding to the resource date may be determined, and then the last updated resource date rank first among the search results. Therefore, the user behavior data always store the last data information, so the results of sorting the at least one type of resource data according to the user behavior data always conform to the last behavioral habits of the user, thus enhancing the hit rate of the search results.

According to another optimal embodiment of the present disclosure, the method may also include: displaying recommended search terms according to the user behavior data in the process that a user enters search terms.

Specifically, according to the present disclosure, when a user enters search terms, some individual pre-determined results, search contents that the user may want, which are guessed in advance, may be supplied to users according to the user behavior data and according to the contents entered by the user. For example, from the user behavior data it is known that a current user is interested in Cecilia Cheung, who is a famous movie star born in Hong Kong. When the user enters “Cheung”, recommended search terms may be provided below the search input box for the user, with “Cecilia Cheung” ranking first. The user may directly select the recommended search terms, avoiding full input of the search terms, thus shortening the user's search time.

According to another optimal embodiment of the present disclosure, the method may also include steps as follows.

Step 31: Search the resource database according to the user behavior data to obtain at least one type of recommended data resources corresponding to the user behavior data.

Step 32: Sending at least one type of recommended resource data to the terminal.

According to this embodiment of the present disclosure, except that at least one type of resource data searched may be displayed to the user, recommended resource data conforming to the user behavioral habits, interests and hobbies may be displayed to the user according to the user behavior data. For example, when the user enters the search terms “Cecilia Cheung”, the plurality of types of resource data including songs, movies, wallpapers, news, etc. about “Cecilia Cheung” are searched and displayed to the user. Besides, through statistics operation on the historical search behaviors, concerns, collection behaviors, etc. of the user, it may be determined that the user interest information of the user is movies of Jay Chou, and then the movies of Jay Chou may be found from the resource database and displayed to the user as recommended resource data, for example the recommended resource data may be displayed in the search result interface.

Step 204: Sending at least one type of resource data after sorting to the terminal.

In conclusion, this embodiment of the present disclosure sorts the at least one type of resource data according to the user behavior data such that search results conforming to the user behavioral habits, interests and hobbies are displayed to every users. Through this embodiment of the present disclosure, the resource data more concerned by the current user may rank first among the search results, thus improving the user experience and enhancing the hit rate of the search results.

### Embodiment 3

On the basis of the first or second embodiment, this embodiment may also include the following optional technical solution.

Relative to the first or second embodiment, the resource database may specifically include a network resource database and/or a local resource database, wherein the network resource database stores the mapping relationships between network resource data and key words, and the local resource database stores the mapping relationships between the local resource data and key words. Therefore, according to this embodiment of the present disclosure, except network resources, such as songs and movie resources in the network, which may be searched according to the search terms entered by the user, local resources, such as contacts and photos in the mobile phone may be searched according to the search terms entered by the user.

The detailed process of searching the network resources and local resources according to the embodiment of the present disclosure is described below. Refer to FIG. 3, which illustrates a step flowchart of a method for processing resources according to the third embodiment of the present disclosure. The method specifically may include the following steps.

Step 301: Receive search terms entered by a user.

Step 302: Search a network resource database according to the search terms to obtain at least one type of network resource data matched with the search terms, wherein the network resource database stores the mapping relationships between various network resource data and key words.

Step 303: Search a local resource database according to the search terms to obtain local resource data matched with the search terms, wherein the local resource database stores the mapping relationships between local resource data and key words. In specific implementation, the sequence of Step 302 and Step 303 may be set upon application situations, which means Step 302 may be executed after Step 303 or Step 302 and Step 303 may be executed synchronously.

Step 304: Display at least one type of network resource data and/or local resource data.

Step 305: According to a user's selected operation on the at least one type of network resource data and/or local resource data, call a corresponding application to display the network resource data and/or local resource data corresponding to the selected operation in the application.

In the above embodiments, searching network resource data is taken as an example in the description. In this embodiment of the present disclosure, local resource data may be searched according to search terms. Specifically, local resource data may include resource data stored in the current electronic device. For example, contacts, photos, etc. in the mobile phone.

According to this embodiment of the present disclosure, a local resource database storing local resource data may be established, and the mapping relationships between the local resource data and the key words are stored therein. For example, after the search term “San Zhang” is received, the contact information corresponding to “San Zhang” may be found in the mapping relationship between the local resource data and the key word through searching the local resource database.

Specifically, the local resource database may be established by the same method as mentioned in the above embodiments for establishing the resource database. For example, the method includes the steps of: first, collecting various local resource data according concern labels; then, establishing the mapping relationships between the concern labels and various local resource data; and finally, storing the mapping relationships between the concern labels and various local resource data into the local resource database. Of course, in actual application, other modes may be used to establish the local resource database. The present disclosure has no limit in the establishment method of the local resource database.

Specifically, after the contact information corresponding to “San Zhang” is found, the contact list application may be opened, and the contact list shows the information about the contact “San Zhang”, and then the user may directly make a call to “San Zhang” or send a message, etc. Thus, the process that the user is required to find the contact list application and then find the contact in the contact list may be avoided, simplifying local resource search and enhancing the efficiency of local resource search.

In actual application, search terms for searching network resource data and search terms for searching local resource data may be acquired from the same search input box, or acquired from two different search input boxes. For example, a user enters a search term “Andy Lau”, who is a famous star. For this search term, corresponding resource data may be found in both network resources and in local resources. Therefore, this search term, “Andy Lau” may be respectively searched in the network resource database and the local resource database, and the results of searching the network resource database and the local resource database are respectively displayed to the user to be selected. Or, before the search, a prompt box may pop out to ask the user to search the network resource database or the local resource database; then the corresponding database is searched according to the user's selection, and the corresponding research result is fed back.

Through this embodiment of the present disclosure, the user may search the resource data corresponding to various applications by entering the search term once, including network resource data and local resource data. Searches repeated in all applications by the user may be avoided, thus enhancing the search efficiency, simplifying the user's efficiency and improving the user experience.

### Fourth Embodiment

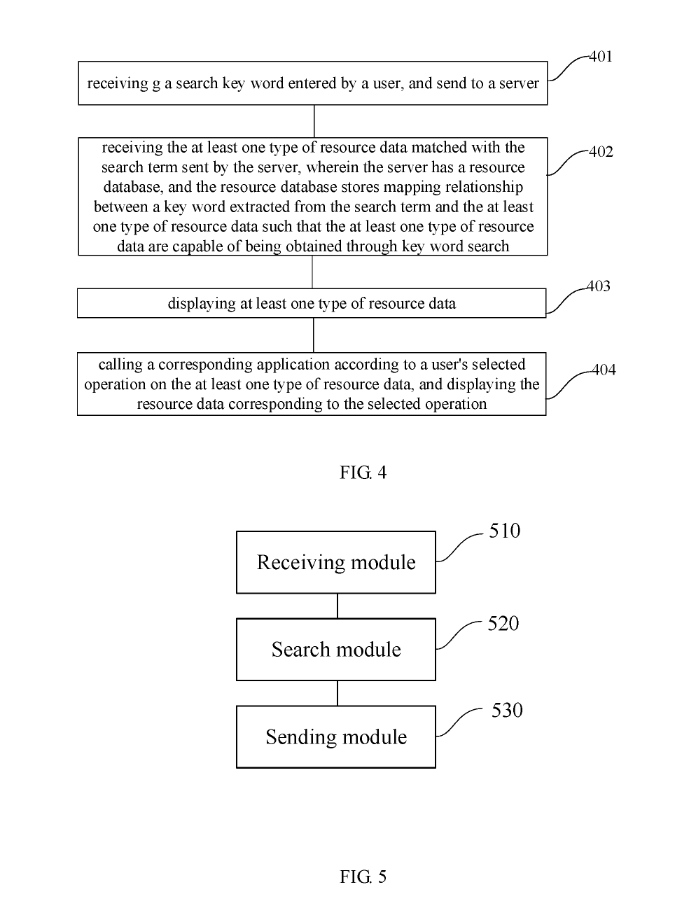

Referring to FIG. 4, it is a step flowchart of a method for processing resources according to a fourth embodiment of the present disclosure; which may include:

Step 401, receiving g a search key word entered by a user, and send to a server;

In this step, the embodiment of the present disclosure may be applied to support of a search client with a search function. The search client may operate in an electronic device such that a user conveniently enters search terms into the search client through the electronic device. To better understanding, the embodiment of the present disclosure mainly takes a mobile phone as an example for description, which may be a cross reference for tablet personal computers, PCs (personal computers) and other electronic devices.

According to one application example of the present disclosure, a search interface of the search client displays a search input box, and the search input box receives search terms entered by users. For example, a search term entered by a user is “Jay Chou”. The terminal receives the search term input by the user and then sends to the server, the server receives the search term sent by the server. Of course, in actual application, for those ordinarily skilled in this field, various input modes such as keypad input, handwriting input and voice input are supported by the terminal, and the embodiment of the present disclosure has no limit in the specific input mode, as long as the server may receive the search term from the terminal.

Step 402, receiving the at least one type of resource data matched with the search term sent by the server, wherein the server has a resource database, and the resource database stores mapping relationship between a key word extracted from the search term and the at least one type of resource data such that the at least one type of resource data are capable of being obtained through key word search.

The embodiment of the present disclosure may integrate different types of resource data into a resource database such that the resource database stores various mapping relationships between key word and a plurality of types of resource data. Here, the key words may be used to represent indexes of a plurality of types of resource data in the resource database. To search the resource database according to the search terms, matching between the search terms and the key words in the resource database is implemented; and the matching succeeds, at least one type of resource data corresponding to the key words may be used as at least one type of resource data matched with the search terms; if the matching between the search terms and all key words in the resource database fails, it may be regarded that the search fails, which means that the resource data does not include at least one resource data matched with the search terms, wherein the resource data may be involved with any APP (Application), for example, calendars, wallpapers, songs, videos, shopping, tickets, weather, travel, maps, etc. For example, songs related to Jay Chou in the song APP, movies and MV participated by Jay Chou in the video APP, high-definition wallpapers concerning Jay Chou in the wallpaper APP, events and dynamics about Jay Chou in calendar APP may be integrated into the resource database. In this way, when the user enters the search terms “Jay Chou”, data resources, corresponding to various APPs, matched with “Jay Chou” may be searched in the resource database, and then resources data corresponding to various APPs may be searched by one search operation, avoiding users from repeatedly searching different APPs and enhancing search efficiency.

Step 403, displaying at least one type of resource data.

In the embodiment of the present disclosure, a plurality of types of resource data obtained by search according to the search terms, for example songs, movies, MVs, wallpapers, etc. corresponding to the search terms “Jay Chou”, may be displayed on the search interface for being operated by a user, for example browse or selection.

S404, calling a corresponding application according to a user's selected operation on the at least one type of resource data, and displaying the resource data corresponding to the selected operation.

According to the embodiment of the present disclosure, according to the resource data selected by the user, an application corresponding to the resource data may be directly called and opened, and the application may display the resource data. Wherein the application corresponding to the resource data may be used for representing the application of the resource data corresponding to the selected operation. For example, when the resource data corresponding to the selected operation are song resources, the corresponding application may be an audio player; for the movie resources, the corresponding application may be a video player; for example again, when the resource data corresponding to the selected operation are wallpaper resources, the corresponding application may be a photo viewer. The applications may specifically be application clients installed in an electronic device. Compared with applications embedded by the existing search engines in the webpages, the application clients have more functions than those of the webpage type applications to facilitate use by users, and are independent from the search access, thus bringing better experience for users.

In an optional embodiment of the present disclosure, in the step of receiving the at least one type of resource data matched with the search term sent by the server, the at least one type of resource data are at least one type of resource data which are sorted according to user behavior data; and the step of displaying at least one type of resource data comprises: displaying the sorted at least one type of resource data.

The step may be referred to step 203, which is not illustrated for concise purpose.

In an optional embodiment, the method further includes: receiving at least one type of recommended resource data corresponding to the user behavior data, wherein the recommended resource data are obtained by searching the resource database according to the user behavior data; and displaying at least one type of recommended resource data.

The steps may be referred to step S31 and S32, which are not illustrated for concise purpose.

In an optional embodiment, the method further includes: displaying recommended search term according to the user behavior data in the process of receiving the search terms entered by the user.

In conclusion, in the embodiment, it is capable to receive a search term entered by a user, and sending the search term to a server; receive the at least one type of resource data matched with the search term sent by the server, wherein the server has a resource database, and the resource database stores mapping relationship between a key word extracted from the search term and the at least one type of resource data such that the at least one type of resource data are capable of being obtained through key word search; display at least one type of resource data; and call a corresponding application according to a user's selected operation on the at least one type of resource data, and displaying the resource data corresponding to the selected operation, thus changing the situation that the user needs to repeatedly search different search engines to obtain different types of resource data. Therefore, the search operation of the user is simplified, search efficiency enhanced, and user experience improved

### Application Example

The realization process of the method for processing resources according to the present disclosure is described with reference to specific application examples.

For example, a user logged in the Letv video application in a mobile phone by using a Letv account number, searched and watched a TV play Tiger Mom. At this time, the search client of the present disclosure may record the user identifier information and user behavior of the user, and correlates the user behaviors to the search term “Tiger Mom” and “Vicki Zhao”, who is the chief actress in the play.

In actual application, a resource database may be established in advance, and the resource database may include the user identifier information, user's Letv account number, the search term “Tiger Mom” and the correspondence between the related contents and the Letv video application, wherein the related contents refer to information about “Tiger Mom”, for example the actors and actresses, director, episodes, entertainment reports, of this play.

When the user logs in the Letv video application next time and searches the term “Vicki Zhao”, the user may search and obtain films and TV plays, related music albums, high-definition wallpapers, recent event dynamics, etc. in the resource database, including the TV play “Tiger Mom”. From the recorded user behaviors it may be known that, the user recently watched the TV play “Tiger Mom” in which Vicki Zhao is the main actress, so the TV play “Tiger Mom” will be marked with high weight, so “Tiger Mom” may rank first among the search results.

Besides, through the recorded user behaviors, when a user enters search terms, some individual pre-determined results, search contents that the user may want, which are guessed in advance, may be supplied to users according to the contents entered by the user. For example, through user behaviors it is known that a user is interested in Cecilia Cheung. When the user enters “Cheung”, recommended search terms may be provided below the search input box for the user, with “Cecilia Cheung” ranking first. The user may directly select the recommended search terms, avoiding full input of the search terms, thus shortening the user's search time.

In actual application, the correlations between different resource data and the APPs may be established in advance; when the user selects the search results, the corresponding APP may be opened through the user's selected operation, for example, if the user selects video resource data, the system directly skips to the play interface of the Letv video application; if the user selects the wallpaper resource data, the system directly skips to the wallpaper APP; and if the user the selects music resource data, the system directly skips to the play interface of the music APP.

### Device Embodiment

FIG. 5 is a structural block diagram of a device for processing resources according to an embodiment of the present disclosure. The device may specifically include:

a receiving module 510 for receiving search terms sent by a terminal;

a search model 520 for extracting key words from the search terms, searching a resource database according to the key words to obtain at least one type of resource data matched with the search terms, wherein the resource database stores mapping relationships between each key word and at least one type of resource data; and

a sending module 530 for sending the at least one type of resource data matched with the search terms to the terminal such that the terminal calls a corresponding application according to a user's selected operation on the at least one type of resource data, and showing the resource data corresponding to the selected operation.

In an optional embodiment of the present disclosure, the device also includes:

a sorting module for sorting the at least one type of resource data according to the user's behavior data;

then, the sending module includes:

a sending sub-module for sending the sorted at least one type of resource data to the terminal.

In an optional embodiment of the present disclosure, the sorting module may specifically include:

a behavior data search sub-module for searching the user behavior data corresponding to the user identifier information from the mapping relationship between the user identifier information and the user behavior data; and,

a sorting sub-module for sorting the at least one type of resource data according to the user's behavior data.

In an optional embodiment of the present disclosure, the user behavior data comprise historical application information; then, the sorting sub-module includes:

a first sorting unit for sorting the at least one type of resource data according to the correlation between the resource data and the historical application information.

In an optional embodiment of the present disclosure, the user behavior data comprise user interest information; then, the sorting sub-module includes:

a second sorting unit for sorting the at least one type of resource data according to the correlation between the resource data and the user interest information.

In an optional embodiment of the present disclosure, the device may also include:

an update module for updating the user behavior data according to the user's selected operation on the at least one type of resource data.

In an optional embodiment of the present disclosure, the device may also include:

a recommended resource search module for searching the resource database according to the user behavior data to obtain at least one type of recommended data resources corresponding to the user behavior data; and

a recommended resource sending module for sending the at least one type of recommended resource data to the terminal.

In an optional embodiment of the present disclosure, the device may also include:

a search term recommending module for displaying recommended search terms according to the user behavior data in the process that a user enters search terms.

In an optional embodiment of the present disclosure, the resource database comprise a network resource database and/or a local resource database;

wherein the network resource database stores the mapping relationship between every key word and the at least one type of network resource data, and the local resource database stores the mapping relationship between every key word and the at least one type of local resource data.

In an optional embodiment of the present disclosure, the device also includes a resource database establishment module for establishing the resource database;

wherein the resource database establishment module comprises:

a resource collection sub-module for collecting a plurality of types of resource data according to the key words;

a mapping relationship establishment sub-module for establishing mapping relationships between the key words and the plurality of types of resource data;

a storage sub-module for storing the mapping relationships between the key words and the plurality of types of resource data into the resource database.

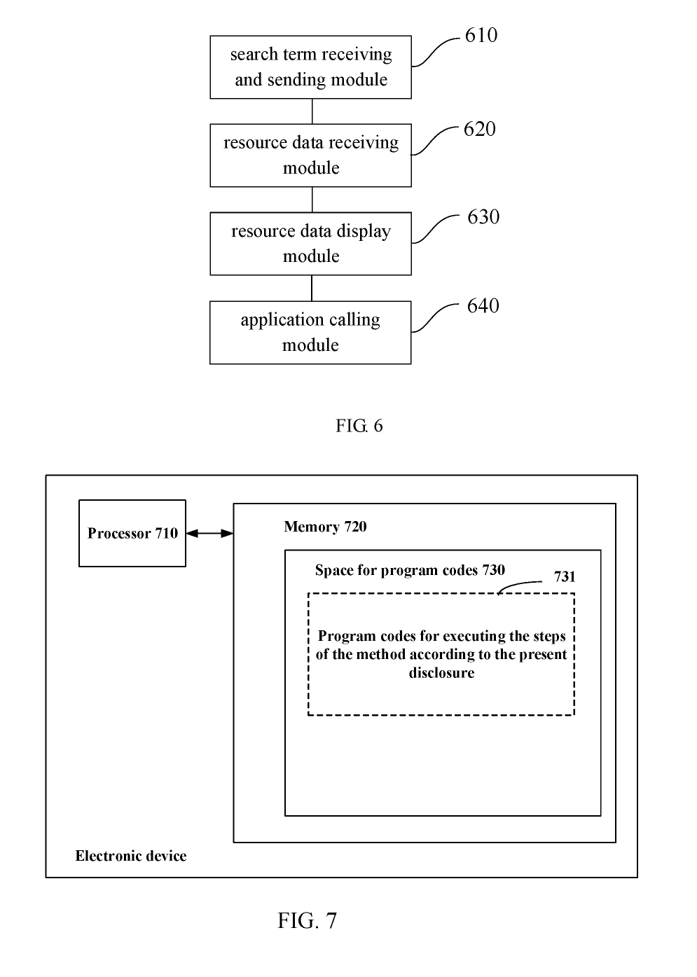

Referring to FIG. 6, it is a structural block diagram of a device for processing resources according to an embodiment of the present disclosure. The device may specifically include:

a search term receiving and sending module 610 for receiving search terms entered by a user, and sending the search terms to a server;

a resource data receiving module 620 for receiving the at least one type of resource data matched with the search terms sent by the server, wherein the server has a resource database, and the resource database stores the mapping relationships between key words extracted from the search terms and the at least one type of resource data such that the at least one type of resource data are capable of being obtained through key word search;

a resource data display module 630 for displaying at least one type of resource data;

an application calling module 640 for calling a corresponding application according to a user's selected operation on the at least one type of resource data, and displaying the resource data corresponding to the selected operation.

In an optional embodiment of the present disclosure, the at least one type of resource data received by the resource data receiving module are at least one type of resource data which are sorted according to user behavior data;

and the resource data display module is used for displaying the sorted at least one type of resource data.

In an optional embodiment of the present disclosure, the device further includes:

a recommended resource receiving module for receiving at least one type of recommended resource data corresponding to the user behavior data, wherein the recommended resource data are obtained by searching the resource database according to the user behavior data; and

a recommended resource display module for displaying at least one type of recommended resource data.

In an optional embodiment of the present disclosure, the device further includes:

a search term recommending module for displaying recommended search terms according to the user behavior data in the process of receiving the search terms entered by the user.

The device embodiment described above is schematic, wherein units described as separable parts may be or may be not physically separated, and components displayed as units may be or may be not physical units, which means that the units may be positioned at one place or distributed on a plurality of network units. Some or all modules may be selected to fulfill the objective of the solution in the embodiment upon actual demands. Those ordinarily skilled in this field may understand and implement the present disclosure without creative work.

The part embodiments of the present disclosure may be hardware, or software modules operating on one or more processors, or combinations thereof. Those ordinarily skilled in this field understand that, in practice, a micro-processor or a digital signal processor (DSP) may be used to conduct some or all functions of some or all parts in the electronic device according to the embodiments of the present disclosure. The present disclosure may also realize some or all device or equipment programs (for example, computer programs and computer program products) of methods described here. Such programs for realizing the present disclosure may be stored in computer readable media, or may be in forms with one or more signals. Such signals may be downloaded from the Internet, or supplied by carrier signals, or supplied in any other ways.

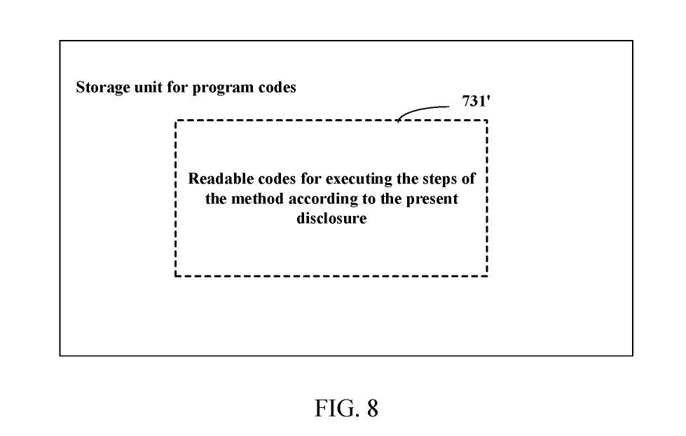

For example, FIG. 7 illustrates an electronic device for realizing the method for processing resources according to the present disclosure, such as the electronic device (for example a terminal) capable of searching the client, or the server. The electronic device traditionally includes a processor 710 and computer program products or computer readable media in form of memories 720. The memories 720 may be electronic memories such as flash memories, EEPROM (electrically-erasable programmable ROM), EPROM, hard discs, or ROM. The memories 720 have storage space 730 for program codes 731 for executing any steps of the above methods. For example, the storage space 530 for program codes may include the program codes 731 for respectively executing all steps of the above methods. The program codes may be read from one or more computer program products or written into one or more computer program products. The computer program products include program code carriers such as hard discs, compact discs (CD), memory cards, or floppy discs. Such computer program products are usually portable or fixed storage units as shown in FIG. 8. The storage units may have storage segments, storage space, etc. similar to the memories 720 in the electronic device as shown in FIG. 7. The program codes may be compressed in a proper form. Usually, a storage unit includes computer readable codes 731′, namely code which may be read by a processor similar to the processor 710. When the codes operate on the electronic device, the electronic device executes the steps of methods described above.

Besides, typically, the electronic device according to the present disclosure may be any of various hand-held devices, for example, a mobile phone, a personal digital assist (PDA), etc., so the protective scope of the present disclosure is not limited to a certain specific type of electronic devices.

Besides, according to the method of the present disclosure, a CPU may execute the computer programs, and the computer programs may be stored in the computer read media. When the computer programs are executed by the CPU, the above functions defined in the methods of the present disclosure are conducted.

Besides, for the above method steps and the system units may be implemented by using the controller or the computer read media for storing the computer programs through which the controller realizes the above steps or unit functions.

Those ordinarily skilled in this field understand that various exemplary logic blocks, modules, circuits and algorithm steps described here may be implemented as electronic hardware, computer software or combination of the two. In order to clearly describe the interchangeability of the hardware and software, the various exemplary logic blocks, modules, circuits and steps have been generally described. The realization of the functions as software or hardware depends on specific applications and design constraints applied to the whole system. Those ordinarily skilled in this field may realize the functions of every specific application in various forms, but such realization cannot be explained to be out of the protective scope of the present disclosure.

The various exemplary logic blocks, modules and circuits described here may be implemented or executed by using the such parts as the universal processor, digital signal processor (DSP), application-specific integrated circuit (ASIC), field programmable gate array (FPGA) or other programmable logic devices, separate gates, or transistor logistic units, separate hardware components or any combinations of those parts deigned for executing the functions. The universal processor may be a micro-processor, but alternatively, the processor may be any traditional processor, controller, micro controller or state machine. The processor may also be implemented as a combination of computer devices, for example a combination of a DSP and a micro-processor, a plurality of micro-processors, one or more micro-processors in combination with a DSP core, or any other such configurations.

The steps of the methods or algorithms described here may be directly included in the hardware, the software module executed by the processor, or combination of the former two. The software module may reside in RAM memories, flash memories, ROM memories, EPROM memories, EERROM memories, registers, hard discs, movable discs, CD-ROM, or any other storage media known in this field. Exemplary storage media are coupled to the processor such that the processor may read information from the storage media or write information into the storage media. In an alternative solution, the storage media may be integrated with the processor. The processor and the storage media may residue in an ASIC (Application Specific Integrated Circuit). The ASIC may residue in a user terminal. In an alternative solution, the processor and the storage media may reside in the user terminal as separate parts.

In one or more exemplary designs, the functions may be conducted in hardware, software, firmware or any combinations thereof. In the case of realization in the software, the functions may be stored in computer readable media as one or more instructions or codes or be transmitted through the computer readable media. The computer readable media include computer storage media and communication media, and the communication media include any media favorable for transmission of computer programs from one position to another position. The storage media may be any usable media capable of being accessed by a universal or special computer. As an example instead of limit, the computer readable media may include RAM, ROM, EEPROM, CD-ROM or other optical disc storage devices, magnetic disc storage device or other magnetic storage devices, or may be any other media which may be used for carrying or storing application codes stored in form of instructions or data structures and may be accessed by a universal or special computer or a universal or special processor. Besides, any connection may be properly called computer readable media. For example, if the software is sent from other websites, servers or other remote sources by using coaxial cables, optical fiber cables, twisted cables and digital subscriber lines (DSL) or wireless technologies such as infrared rays, radio waves and microwaves, then the coaxial cables, optical fiber cables, twisted cables and digital subscriber lines (DSL) or wireless technologies such as infrared rays, radio waves and microwaves are all included in the definition of the media. For example, magnetic discs and optical discs including compact discs (CD), laser discs, optical discs, digital video discs (DVD), floppy discs and blue-ray discs used here are included, wherein the magnetic discs usually magnetically display data, and the optical discs display data in the principle of laser optics. Combinations of the above contents are also included in the scope of computer readable media.

The above are public exemplary embodiments. It is required to be noted that, various changes and modifications may be made within the scope of contents defined by the Claims. According to the described public embodiments, the functions, steps and/or actions claimed by the Claims are executed without any specific sequence. Besides, the public elements may be described or claimed as individuals, but a plurality of elements may be provided unless the number is clearly defined as an odd number.

It should be understood that, in the text, unless clearly exemplified in the context, the singular forms “a”, “an” and “the” also means plural forms. It should also be understood that, the words “and/or” in the text also includes one or any and all combinations of more than one correlatively listed item.

The sequence numbers of the above public embodiments are used for description only, and do not represent the superiority of the embodiments.

Those ordinarily skilled in this field understand that all or some steps of the above embodiments may be completed through hardware, or completed by related hardware instructed by programs. The programs may be stored in a computer readable media, and the above storage media mentioned above may be read-only memories, magnetic discs or optical discs.

Through the description of the above embodiments, those ordinarily skilled in this field clearly know that the embodiments may be implemented by software and necessary universal hardware platforms, or by hardware. Based on this understanding, the above solutions or contributions thereof to the prior art may be reflected in form of software products, and the computer software products may be stored in computer readable media, for example, ROM/RAM, magnetic discs, optical discs, etc., including various instructions, which are used for driving a computer device (which may be a personal computer, a server or a network device) to execute methods described in all embodiments or in some parts of the embodiments.

Finally, it should be noted that, the above embodiments are used to describe instead of limiting the technical solution of the present disclosure; although the above embodiments describe the present disclosure in detail, those ordinarily skilled in this field understand that they may modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for processing resources, comprising:
receiving a search term sent by a terminal;
extracting a key word from the search term, searching a resource database according to the key word to obtain at least one type of resource data matched with the search term, wherein the resource database stores the mapping relationship between every key word and the at least one type of resource data;
sending the at least one type of resource data matched with the search term to the terminal such that the terminal calls a corresponding application according to a user's selected operation on the at least one type of resource data, and shows the resource data corresponding to the selected operation.

2. The method according to claim 1, wherein a resource database is searched according to the key words to obtain at least one type of resource data matched with the search terms; the method further comprises: sorting the at least one resource data according to user behavior data,
the step of sending the at least one type of resource data matched with the search term comprises: sending the sorted at least one type of resource data to the terminal.

3. The method according to claim 2, wherein the step of sorting the at least one type of resource data according to user behavior data comprises:
searching the user behavior data corresponding to user identifier information from the mapping relationship between the user identifier information and the user behavior data; and
sorting the at least one type of resource data according to the user behavior data.

4. The method according to claim 3, wherein the user behavior data comprise historical application information, and then the step of sorting the at least one type of resource data according to user behavior data comprises:
sorting the at least one type of resource data according to the correlation between the resource data and the historical application information.

5. The method according to claim 3, wherein the user behavior data comprise user interest information, and the step of sorting the at least one type of resource data according to user behavior data comprises:
sorting the at least one type of resource data according to the correlation between the resource data and the user interest information.

6. The method according to claim 3, wherein the method further comprises:
updating the user behavior data according to the user's selected operation on the at least one type of resource data.

7. The method according to claim 2, wherein the method further comprises:
searching the resource database according to the user behavior data to obtain at least one type of recommended data resources corresponding to the user behavior data; and
sending the at least one type of recommended resource data to the terminal.

8. The method according to claim 1, wherein the resource database comprise a network resource database or a local resource database;
wherein the network resource database stores the mapping relationship between every key word and the at least one type of network resource data, and the local resource database stores the mapping relationship between every key word and the at least one type of local resource data.

9. The method according to claim 1, wherein the resource database is established by the following steps of:
collecting a plurality of types of resource data according to the key word;
establishing the mapping relationships between the key word and the plurality of types of resource data; and
storing the mapping relationships between the key word and the resource data into the resource database.

10. A method for processing resources, comprising:
receiving a search term entered by a user, and sending the search term to a server;
receiving the at least one type of resource data matched with the search term sent by the server, wherein the server has a resource database, and the resource database stores mapping relationship between a key word extracted from the search term and the at least one type of resource data such that the at least one type of resource data are capable of being obtained through key word search;
displaying at least one type of resource data;
calling a corresponding application according to a user's selected operation on the at least one type of resource data, and displaying the resource data corresponding to the selected operation.

11. The method according to claim 10, wherein in the step of receiving the at least one type of resource data matched with the search term sent by the server, the at least one type of resource data are at least one type of resource data which are sorted according to user behavior data; and
the step of displaying at least one type of resource data comprises: displaying the sorted at least one type of resource data.

12. The method according to claim 11, wherein the method further comprises:
receiving at least one type of recommended resource data corresponding to the user behavior data, wherein the recommended resource data are obtained by searching the resource database according to the user behavior data; and,
displaying at least one type of recommended resource data.

13. The method according to claim 10, wherein the method further comprises:
displaying recommended search term according to the user behavior data in the process of receiving the search terms entered by the user.

14. An electronic device for processing resources, comprising:
at least one first processor; and
a first memory communicably connected with the at least one first processor for storing instructions executable by the at least one first processor, wherein execution of the instructions by the at least one first processor causes the at least one first processor to:
receive search terms sent by a terminal;
extract a key word from a search term, search a resource database according to the search term to obtain at least one type of resource data matched with the search term, wherein the resource database stores mapping relationship between each key word and at least one type of resource data; and
send the at least one type of resource data matched with the search term to the terminal such that the terminal calls a corresponding application according to a user's selected operation on the at least one type of resource data, and show the resource data corresponding to the selected operation.

15. The electronic device according to claim 14, wherein execution of the instructions by the at least one processor causes the at least one processor to further:
sort the at least one type of resource data according to the user's behavior data;
send the at least one type of resource data matched with the search term comprises:
send the sorted at least one type of resource data to the terminal.

16. The electronic device according to claim 15, wherein sort the at least one type of resource data according to the user's behavior data comprises:
search user behavior data corresponding to user identifier information from mapping relationship between the user identifier information and the user behavior data; and,
sort the at least one type of resource data according to the user behavior data.

17. The electronic device according to claim 16, wherein the user behavior data comprise historical application information; sort the at least one type of resource data according to the user behavior data comprises:
sort the at least one type of resource data according to the correlation between the resource data and the historical application information.

18. The electronic device according to claim 16, wherein the user behavior data comprise user interest information; sort the at least one type of resource data according to the user behavior data comprises:
sort the at least one type of resource data according to the correlation between the resource data and the user interest information.

19. The electronic device according to claim 15, wherein execution of the instructions by the at least one processor causes the at least one processor to further:
display recommended search terms according to the user behavior data in the process that a user enters search term.

20. The electronic device according to claim 14, wherein the resource database comprise a network resource database or a local resource database;
wherein the network resource database stores the mapping relationship between every key word and the at least one type of network resource data, and the local resource database stores the mapping relationship between every key word and the at least one type of local resource data.
